(19) United States
(12) Patent Application Publication
(10) Pub. No.: US 2017/0248875 A1
(43) Pub. Date: Aug. 31, 2017

(54) PRINTERS

(71) Applicant: HEWLETT-PACKARD INDIGO B.V., Amstelveen (NL)

(72) Inventor: Boaz TAGANSKY, Rishon Letzion (IL)

(21) Appl. No.: 15/519,797

(22) PCT Filed: Oct. 30, 2014
(86) PCT No.: PCT/EP2014/073331

§ 371 Date: Apr. 17, 2017

(51) Int. Cl. G03G 15/01

(52) U.S. Cl. CPC G03G 15/1605

(57) ABSTRACT

Printers comprising a plurality of imaging units are described. In an example, each imaging unit selectively deposits at least one printing substance and an intermediate transfer member cooperates with the imaging units such that, in use of the printer, a printable image may be formed thereon, the printable image comprising printing substance from at least two imaging units.

### BACKGROUND

Printing involves technologies in which printing substance(s), often including colored dyes or pigments, are applied to a substrate. Known printing techniques include inkjet printing, electrophotographic printing, laser printing and thermal transfer printing.

### DETAILED DESCRIPTION

This disclosure is not limited to the particular materials and process steps disclosed herein because such materials and process steps may vary somewhat. The terminology used herein is used for the purpose of describing particular examples only. The terms are not intended to be limiting because the scope of the present disclosure is intended to be limited only by the appended claims and equivalents thereof.

It is noted that, as used in this specification and the appended claims, the singular forms “a,” “an,” and “the” include plural referents unless the context clearly dictates otherwise.

As used herein, the term “substantially” or “substantial” refers to the complete or nearly complete extent or degree of an action, characteristic, property, state, structure, item, or result.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

### BRIEF DESCRIPTION OF THE FIGURES

FIGS. 1 and 2 show examples of printers;

FIG. 3 shows an example of a method of printing with printing substances;

FIG. 4 shows a further example of a printer; and

FIG. 5 shows another example of a method of printing with printing substances.

Some printing apparatus or printers (which term, as used herein, encompasses printing presses) comprise at least one imaging unit for applying printing substance (e.g. inks or toners) to a substrate, either directly or via at least one intermediate member.

As used herein, an ‘imaging unit’ is a component of a printer which is capable of supplying a printing substance in a form to provide a printed image. In other words, the printing substance is emitted from the imaging unit having, or so as to have, substantially the form or pattern which that printing substance is intended to have on the substrate. In some examples, printing substance may be applied directly from an imaging unit to a substrate. In some examples, printing substance may be conveyed to a substrate by an intermediate member. In some examples, an imaging unit may comprise a replaceable component.

Some printers generate colored images by printing separate substantially overlapping images, each image formed of a single colored ink. Some such printers have a number of imaging units, each of which is associated with a color. In one example of such a printer, each imaging unit may apply a colorant to a substrate, one unit after the other. In other printers, a process known as ‘color switching’ can be used. In printers which use color switching, a single imaging unit may be used to apply each of multiple colors in turn.

In an electro-photographic printer, a charge is first placed on a photoconductor, light is used to selectively dissipate charge to form a charge pattern on the photoconductor, and an image is formed on the photoconductor in charged particles (which may be pigmented particles, such as toner particles) which are attracted to or repelled by the charge of the charge pattern. In some examples of such printers, the image is transferred to an intermediate transfer member and/or a substrate under pressure and/or the action of an electric field.

Liquid electro-photographic printers are printers which use electrically charged particles suspended in a liquid carrier, sometimes called liquid ‘electroink’, as a printing substance.

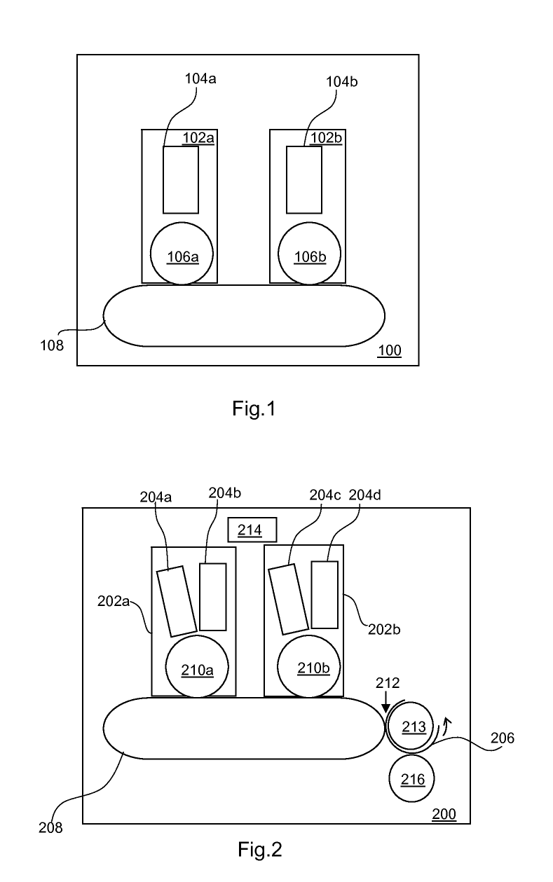

FIG. 1 shows an example of a liquid electro-photographic printer 100 comprising a plurality of imaging units 102a, 102b. Each imaging unit 102 comprises a photoconductive member 106a, 106b and can deposit at least one printing substance 104a, 104b onto an intermediate transfer member 108. The intermediate transfer member 108 cooperates with the imaging units 104a, b such that a printable image is formed thereon, the printable image comprising printing substance from at least two imaging units.

The printing substance in this example may comprise electrically charged pigmented particles suspended in a liquid carrier. In some examples, the printing substances 104a, 104b may be provided in containers, for example in cartridges or the like. An image formed from a printing substance may be selectively added to a particular region of intermediate transfer member 108 as it passes each imaging unit 104a, b. In this way, the region of the intermediate transfer member 108 may acquire a plurality of images in different printing substances which are overlaid on the region and together form a desired image to be printed. In some examples, the desired image made up of one or multiple printing substances may then be transferred to a substrate. This may comprise transferring an image bearing several different printing substances in a single operation, resulting in the quick formation of a desired printed image.

In this example, the intermediate transfer member 108 is an endless belt. In other examples, the intermediate transfer member 108 may be a roller, drum or the like.

In another example, as shown in FIG. 2, a printer 200 comprises a plurality of imaging units 202a, 202b and at least two of such units (and in some examples, each of the imaging units 202a, 202b) is for selectively depositing one of a first and a second, different, printing substance 204a-d in a particular printing operation for transfer to a substrate 206.

In some examples, the first and second printing substances selectively deposited by each imaging unit 202a, b may, in addition to being different from each other, be different from those deposited by any other imaging unit 202a, b. This allows for a variety of combinations of printing substances, for example of colors. In other examples, at least two of the printing substances 204a-d may have common properties, for example comprising the same color, to allow for certain printing effects to be achieved.

In this example, the printer 200 further comprises an intermediate transfer member 208 (in this example, an endless belt) for cooperating with the imaging units 202a, 202b such that printing substance having the pattern desired for the image to be printed is formed on the intermediate transfer member 208. Further, each of the imaging units 202 comprises a photoconductive member 210, in this example a photoconductive drum. In operation of the printer 200, by controlling electrostatic charge, and providing a printing substance which is itself electrically charged, a pattern for transfer to a substrate 206 is first formed by the printing substance on the photoconductive member 210 before being transferred to the intermediate transfer member 208. This pattern may be the image to be printed, or may comprise part of the image, with other printing substances also contributing to the printed image, either by being overlaid on this pattern on the intermediate transfer member 208, or on the substrate 206.

The printer 200 in this example is arranged such that an image comprising printing substance 204a-d from one, some, or each imaging unit 202 may be transferred to the substrate 206 in a single action. In this example, each imaging unit 202 is arranged to apply printing substance to the same region of the intermediate transfer member 208 in turn as the region moves past the imaging unit 202. As shown, therefore, the first imaging unit 202a could apply the first or second printing substance 204a, 204b supplied thereto to a region of the endless belt, which region then moves towards the second imaging unit 202b, such that the first or second printing substance 204c, 204d of the second imaging unit 202b can be overlaid on the same region. The region then moves to a transfer nip 212. At the nip 212, the image may be transferred under pressure to the substrate 206, which may be urged against the intermediate transfer member 208 by a substrate conveying roller 213.

In one example, the printer 200 may therefore provide a printing device comprising a first imaging unit 202a comprising a photoconductive member 210a, the first imaging unit 202a being for selectively supplying a first printing substance or a second printing substance (printing substances 204a and 204b) for transfer to the substrate 206; and a second imaging unit 202b, comprising a photoconductive member 210b, the second imaging unit 202b being to selectively supply a third printing substance or a fourth printing substance (printing substances 204c and 204d) for transfer to the substrate 206. The first imaging unit 202a and the second imaging unit 202b are controlled such that during a printing operation, one printing substance from at least one imaging unit is selectively printed. In some examples, at least two of the printing substances may have different qualities, for example, comprising different colorants, or any combination of colorants, coatings, conductive materials, semi conductive materials, fluorescent materials, etc.

In this example, the printer 200 comprises a controller 214, which controls the printer operations. In particular, the controller 214 controls which printing substance 204a-d is supplied from a particular imaging unit 202a, b, at a particular time and may control other printing or printer processes, such as movement of the intermediate transfer member 208, the substrate conveying roller 213 and the like.

In one example, the first and third printing substances may be printed in a first printing operation, and the second and fourth printing substance may be printed in a second printing operation. In other examples, only one printing substance 204a-d may be printed in a given printing operation, or the combination of printing substances printed in a single printing operation may be varied.

In this example, multiple printing operations may be carried out on the same substrate 206. To that end, the printer 200 in this example comprises a roller 216 to return the substrate 206. In this example the substrate 206 is a flexible sheet substrate such as paper or plastic sheeting or the like, although other substrates, including substrates which are not flexible sheets, such as articles of manufacture (e.g. bottles, discs such as DVDs, Compact disks or the like) may be printed. However, in other examples, the endless belt 208 may complete more than one rotation before the printing substance(s) is/are applied to the substrate 206. In a first rotation, a first printing substance from at least one of the imaging units may be applied to a region of the endless belt 208, which may then make a second rotation, still bearing the printing substance(s) applied thereto in the first rotation, and a second printing substance from at least one imaging unit may be applied to the same region (i.e. the application of printing substance on each rotation may constitute a printing operation). The printing substances applied during the first and second rotations may be transferred to the substrate 206 in a single action.

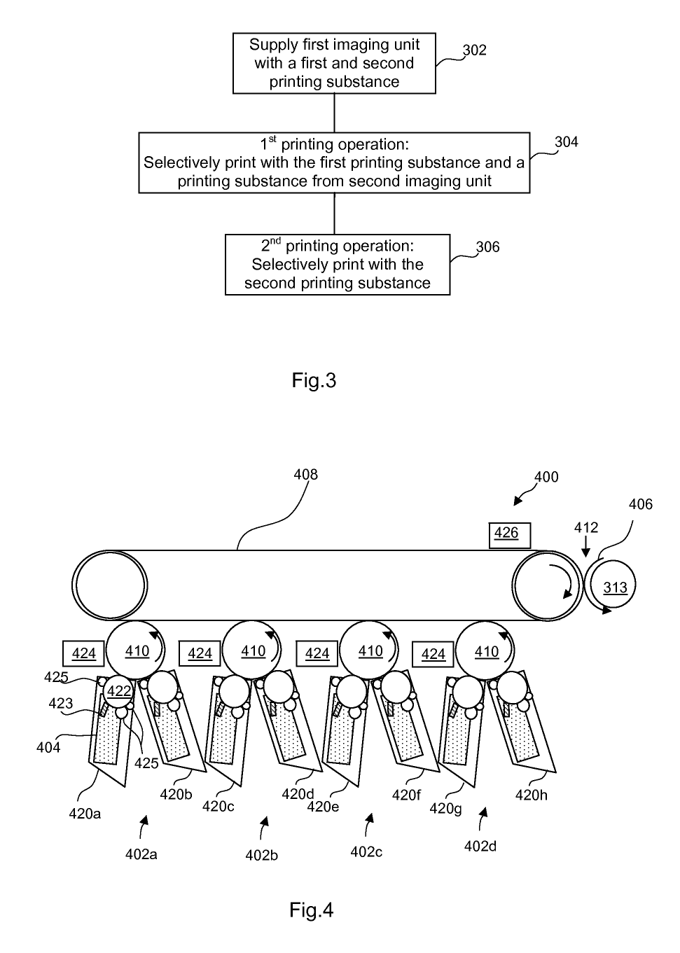

In one example, with reference to the flow chart of FIG. 3, a method for printing is described. The method comprises supplying a first imaging unit with a first printing substance and a second printing substance (block 302). In a first printing operation, a printer may be controlled to selectively print with the first printing substance and a printing substance from second imaging unit (block 304). In a second printing operation, the printer may be controlled to selectively print with the second printing substance (block 306).

Being able to selectively control at least one imaging unit of a plurality of imaging units to use one of a plurality of printing substances to a produce a printed image allows a variety of printing effects to be produced. For example, if the first imaging unit first supplies a first printing substance, this may be printed to a substrate on its own, or in combination with a printing substance from the second imaging unit. The first imaging unit may then be controlled, or switched, to carry out a printing operation with the second printing substance, which may again be applied to a substrate on its own or in combination with a printing substance from the second imaging unit, or overprinted on another image (for example the image formed in the first printing operation).

In some examples, the first and the second printing substances may be different colors. This provides versatility in the printed colors the printer is able to produce. For example, a color provided by the second imaging unit may be combined with a color of either (or both) of the first and second printing substances of the first imaging unit. Indeed, in some examples, all of the printing substances may comprise different colors. In other examples, where at least some of the printing substances comprise a colored substance, the first and second imaging unit may print the same color, for example to provide a high color density.

The first and second printing operations may be carried out in any order. As noted above, at least one printing substance may comprise a colorant, such as a colored die or toner. As used herein, the term colorant includes white and black printing substances, as well as other colors, for example yellow, cyan, magenta, red, green and blue, etc. However, a printing substance could also comprise a transparent material, for example intended as a coating, florescent materials, conductive and/or semi-conductive substances, metallic substance, low-friction materials, or any other substance which is suitable for printing.

Each printing operation may comprise printing on a substrate (for example printing an image on a substrate), or may comprise forming an image to be transferred to a substrate. In some examples, each printing operation may comprise forming an image on an intermediate transfer member.

The method may be carried out by a liquid electrophotographic printer. In some examples, the method may comprise heating the printing substances before or as they are applied to a substrate. In some examples, this may comprise heating the printing substance(s) on an intermediate transfer member.

FIG. 4 shows an example of a liquid electrophotographic printer 400. In this example, there are four imaging units 402, each comprising two printing substance supply modules 420a-h and a photo imaging plate (PIP) 410, which provides a photoconductive member. In this example, the modules 420a-h are moveably mounted such that they can be moved to or away from the PIP 410, for example under the control of a controller such as the controller 214 described in relation to FIG. 3 above. Therefore, the printing substance to be applied from an imaging unit 410 is selected by moving an printing substance supply module 420a-h towards the PIP 410 (and de-selected by moving the module 420a-h away from the PIP 410). Using the example of a printing substance comprising electronic ink, a typical ink layer may be around, or less than 0.01 mm thick, so a small movement selects or de-selects an printing substance supply module 420a-h. Other methods of selecting and/or deselecting a printing substance may be used.

The printing substance in this example is a liquid ‘electroink’ comprising electrically charged pigmented particles suspended in a liquid carrier.

At least one printing substance supply module 420a-h may for example comprise a ‘Binary Ink Developer’, or BID. As is labelled in relation to one imaging unit 402, each printing substance supply module 420a-h may comprise a cartridge 404 of electroink, and a transfer roller 422. The transfer roller 422 acquires a thin layer of electroink from the cartridge 404 via the action of an electrode 423. The module 420 further comprises a number of printing substance collection rollers 425 to remove excess or untransferred printing substance from the transfer roller 422. The printing substance on the transfer roller 422 is then transferred to the photo imaging plate (PIP) 410, which is mounted on an imaging cylinder. The PIP 410 is electrostatically charged. Its charged surface is exposed to beams of light from a laser unit 424, which selectively neutralise the charge where light is incident. If the charge of the printing substance and the charge of the PIP 410 are of the same sign, the neutralised area of the PIP 410 attracts printing substance thereto (in some examples, the printing substance and the PIP 410 may be oppositely charged such that the PIP 410 attracts printing substance thereto in the regions in which charge remains). As it rotates, it will attract printing substance from the transfer roller 422 such that it carries a ‘latent image’ that replicates the pattern of the printing substance desired in the image to be printed.

The printing substance is then transferred to an intermediate transfer member 408 using, in this example, electrostatic force. This force is created by charging the intermediate transfer member 408 such that the attractive force thereof exceeds that of the PIP 410. In this example, the intermediate transfer member is an endless belt 408, at least a portion of which is heated with a heating unit 426. In this example, the heating unit 426 comprises an Infra Red (IR) radiation unit located outside the belt 408, which heats a region of the belt 408 before it enters the transfer nip 412. In other examples, a number of heating units 426, which may comprise any, or any combination of, IR radiation units or alternative heaters (e.g. providing an internal heating layer, a microwave radiation unit, a hot air heating unit, or the like), or a combination of different types of heating units may be provided at different locations, which may be inside and/or outside the belt 408. In some examples, substantially all of the belt 408 may be at an elevated temperature, perhaps with a peak temperature in the region of the nip 412.

A printing substance image may selectively be added to a particular region of the endless belt as it passes each PIP 410. In this way, the region of the endless belt may approach a nip 412 bearing up to four overlaid printing substance images, which may be in the form of printing substance layers (there may be more than four layers if the belt 408 undergoes more than one rotation before the printing substance is transferred to the substrate 406). In some examples, the heat softens the printing substance, causing the particles to at least partially melt and blend together and forming pigmented ‘plastic film’. As this plastic film enters the nip 412 and is pressed against a cooler substrate 406 (which is urged against the endless belt 408 by a substrate transfer roller 413), it solidifies and adheres to the substrate 406.

Such imaging units 402 may comprise alternative components, or components in addition to those illustrated, such as squeegees for removing excess printing substance, cleaning stations and the like.

In any given printing operation, either (or neither) of the two printing substances associated with each imaging unit 402 may be used. Thus a large number of combinations of printing substances may be selectively applied to the substrate 406. Each of the eight individual printing substances could each be applied in isolation from any other printing substance, or combinations of two, three or four printing substances could be applied in a printing operation. Therefore, printing substance from one, two or more imaging units 402 may be applied to a substrate 406. Additionally, as noted above in relation to FIG. 2, a single substrate 406 could be subjected to more than one printing operation, or the belt 408 may undergo more than one rotation before transferring printing substances to the substrate 406, allowing further combinations of printing substances to be printed.

In some examples, each of the imaging units 402a-d may be associated with a more frequently used printing substance and a less frequently used printing substance. For example, each of the imaging units 402 may be associated with one of a cyan, a magenta, a yellow and a black cartridge 404. This corresponds to a ‘standard’ set of colors, which might typically be used to print a wide range of images. The other cartridge 404 of each imaging unit 402 may be a less frequently used printing substance, such as one of white, orange, violet and green (the ‘OVG’ color set of orange violet and green, which may increase the range of colors produced by a printer), or one of white, and light versions of cyan, magenta and yellow, or any other printing substances.

In this way, in one example, the printer 400 may comprise a first mode, in which the ‘standard’ CMYK color set is used, and a ‘color switch’ mode, in which at least one of the other printing substances are used, possibly in addition to the CMYK colors, in forming a single image. The ‘standard’ mode may therefore operate at speed. On occasions where the second ‘color switch’ set is desired, a CMYK image, whether on the belt 408 or the substrate 406, may, in some examples, be overprinted with at least one color from the color switch color set. It will be appreciated that the productivity of the printer 400 will be reduced compared to printing with just the ‘standard’ color set as two rotations of the belt 408 are made but compared to changing color cartridges, this can be achieved quickly and easily. A further alternative would be to provide two different printing apparatus, each with a different set of printing substances. However, compared to such a solution, the printers and methods described above mean that one set of ancillary apparatus, such a heaters, belts, drying units, substrate feed motors, etc, is provided and can be used to print both color sets, which reduces the cost while still providing a variety of printing options.

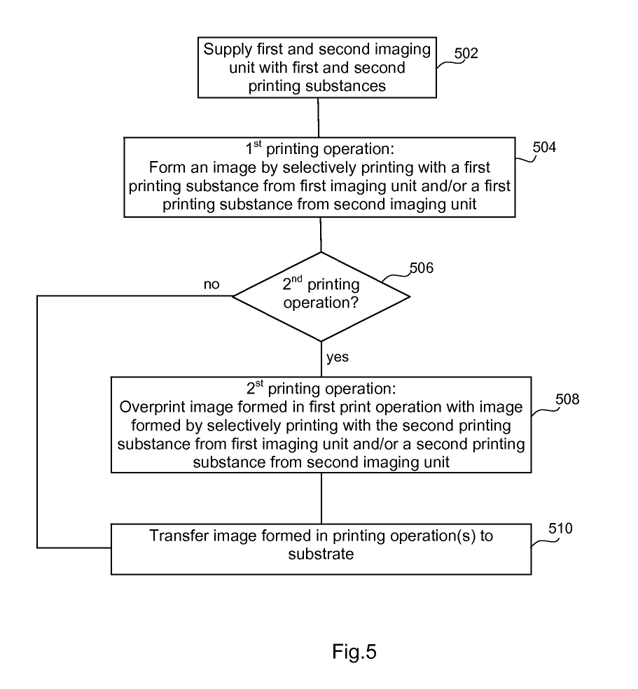

In one example, as now described with reference to FIG. 5, first and second imaging units are each supplied with a first and a second printing substances (block 502). The first printing operation comprises forming an image by selectively printing with the first printing substance and/or a first printing substance from second imaging unit (block 504). It is then determined whether a second printing operation is desired (block 506). If a second printing operation is desired, then the second printing operation, which in this example comprises overprinting the image formed in first printing operation with image formed by selectively printing with the second printing substance of the first and/or second imaging units, is carried out (block 508). The image formed in the first printing operation, and, if it was carried out, in the first and second printing operation(s) are transferred to a substrate (block 510) in a single action.

In such an example, the first printing operation may be carried out with a first frequency, and the second printing operation may be carried out with a second frequency. The second frequency may be lower than the first frequency. The desirability of the second printing operation may, for example, depend on colors and/or quality of the printed image it is desired to produce (for example, whether colors from a second colour set (such as the OVG color set) are desired in addition to colors from a first color set (such as the CMKY color set)), and may for example be determined by a processor or controller of a printer (such as the controller 214 described in relation to FIG. 3). In some examples, the second printing operation may be carried out without performing the first printing operation in order to produce a particular image.

While particular examples comprising two or four imaging units, each being controllable to print one or two printing substances, have been described, more imaging units and/or printing substances per imaging unit could be used in other embodiments.

The printers described in relation to FIG. 1 or FIG. 2 may additionally comprise one or more components described in relation to FIG. 4, such as a PIP or one or more heating units. The blocks of FIG. 3 or 5 may be carried out by any of the printers of FIG. 1, 2 or 4. Any feature or component described in relation to one embodiment may be combined with features of other embodiments.

Some aspects of examples of the present disclosure can be provided as methods, systems or machine readable instructions, such as any combination of software, hardware, firmware or the like. Such machine readable instructions may be provided as a computer software product and/or included on a computer readable storage medium (including but not limited to disc storage, CD-ROM, optical storage, etc.) having computer readable program codes therein or thereon. The machine readable instructions may, for example, be executed by a general purpose computer, a special purpose computer, an embedded processor or processors of other programmable data processing devices to realize the functions described in the description and diagrams. In particular, a controller 214 comprise a processor and may execute the machine readable instructions. The term ‘processor’ is to be interpreted broadly to include a CPU, processing unit, ASIC, logic unit, or programmable gate array etc. The methods and functional modules may all be performed by a single processor or divided amongst several processers.

The present disclosure is described with reference to a flow charts and it shall be understood that some blocks therein can be realized by machine readable instructions.

Although the flow diagrams described above show a specific order of execution, the order of execution may differ from that which is depicted.

While reference to certain examples has been made herein, various modifications, changes, omissions, and substitutions can be made without departing from the spirit of the disclosure. It is intended, therefore, that the disclosure be limited only by the scope of the following claims. The features of any dependent claim can be combined with the features of any of the other dependent claims, and any independent claim.

1. A liquid electro-photographic printer comprising:
an intermediate transfer member and a plurality of imaging units, each imaging unit comprising a photoconductive member;
wherein each imaging unit is to selectively deposit at least one printing substance onto the intermediate transfer member; and
the intermediate transfer member is to cooperate with the imaging units such that, in use of the printer, a printable image is formed on the intermediate transfer member, the printable image comprising printing substance from at least two imaging units.

2. A printer according to claim 1 in which the printing substances of the printable image comprise at least two different colors.

3. A printer according to claim 1 wherein at least one imaging unit is to selectively deposit one of a first and a second, different, printing substance.

4. A printer according to claim 1 in which each of the imaging units is to selectively deposit one of a first and a second, different, printing substance, and the first and second printing substances to be selectively deposited by each imaging unit are different from those deposited by any other imaging unit.

5. A printer according to claim 1 comprising a heating unit to heat at least a portion of the intermediate transfer member.

6. The printer according to claim 1, wherein the intermediate transfer member comprises an endless belt.

7. The printer according to claim 1, wherein each imaging unit comprises an ink supply module.

8. A printing device, comprising:
a first imaging unit, the first imaging unit comprising a photoconductive member to selectively deposit one of a first printing substance or a second printing substance for printing on a substrate; and
a second imaging unit, the second imaging unit comprising a photoconductive member to selectively deposit one of a third printing substance or a fourth printing substance for printing on a substrate;
an intermediate transfer member to cooperate with the imaging units such that, in use of the printing device, a printable image is formed thereon, and to transfer the printable image to a substrate, the printable image comprising a selected printing substance of the first imaging unit and a selected printing substance of the second imaging unit.

9. The printing device according to claim 8, further comprising a controller to select the printing substance deposited by each imaging unit.

10. The printing device according to claim 8, wherein the printing device is a liquid electrophotographic printing device.

11. A method of printing comprising:
supplying a first imaging unit of a printing device with a first and a second printing substance;
in a first printing operation, selectively printing with the first printing substance from the first imaging unit and with a printing substance from a second imaging unit of the printing device; and
in a second printing operation, selectively printing with the second printing substance from the first imaging unit.

12. A method according to claim 11 comprising, in the second printing operation, selectively printing with a printing substance from the second imaging unit.

13. A method according to claim 11 in which each printing operation comprising forming an image and the second printing operation comprises overprinting an image formed in the first printing operation.

14. A method according to claim 11 in which the first printing operation is carried out with a first frequency and second printing operation is carried out with a second, different, frequency.

15. A method according to claim 11 which comprises printing the substrate with printing substance from the first imaging unit and the second imaging unit in a single action.
